(19) United States
(12) Patent Application Publication
(10) Pub. No.: US 2003/0220900 A1
(43) Pub. Date: Nov. 27, 2003

(54) Method and apparatus for deprecating IP addresses

(76) Inventor: Bajko Gabor, Budapest (HU)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/400,396

(22) Filed: Mar. 28, 2003

Related U.S. Application Data
(60) Provisional application No. 60/367,718, filed on Mar. 28, 2002.

(51) Int. Cl. G06F 7/00

(52) U.S. Cl. 707/1

(57) ABSTRACT

A method and apparatus are provided for communicating with other network entities. A user equipment may include a database to list IP addresses of the user equipment and current usage information (such as ‘in use’ or ‘not in use’) of the IP addresses. A determination may be made from the database if the IP addresses stored therein may be deprecated.

This application claims priority from U.S. Provisional Application No. 60/367,718, filed Mar. 28, 2002, the subject matter of which is incorporated herein by reference.

### BACKGROUND

1. Field of the Invention

This present invention relates communications systems. More particularly, the present invention relates to registration within an IP Multimedia Core Network System (IMS).

2. Description of Related Art

An exemplary IP communications network has been described in Release 5 of the specifications of the 3^{rd} Generation Partnership Project (3GPP), the subject matter of which is incorporated herein by reference. Different technical specifications (available at the 3gpp.org website) address various respective aspects of the network.

In 3GPP, at PDP context activation by a user equipment, a gateway general packet radio system service node (GGSN) may provide the UE with an IPv6 prefix rather than a fixed IPv6 address. Using stateless autoconfiguration, the UE may generate an UE interface identifier and append the interface identifier to the received IPv6 prefix.

RFC 3041 (Privacy Extensions for Stateless Address Autoconfiguration in IPv6), the subject matter of which is incorporated herein by reference, describes forming IP addresses by combining network prefixes with an interface identifier. More specifically, a UE implementing methodologies described in RFC 3041 may generate a new interface identifier and obtain a new IP address by adding a newly generated interface identifier to the IPv6 prefix obtained from the GGSN. The UE may then eliminate the old IP address and use the new address.

The Change Request Contribution S2-020919, the subject matter of which is incorporated herein by reference, states “[w]hen a UE is registered in the IM CN Subsystem, any change to the IP address that is used to access the IM CN Subsystem shall trigger automatic registration in order to update the UE's IP address”. Stated differently, the UE may be required to reregister with the IMS network whenever any change occurs to the IP address that is used to access the IM CN Subsystem.

RFC 3041 further describes that a host is free to generate a new IP address whenever the host determines it is necessary (i.e., the preferred lifetime of an address recommended by the RFC may be overwritten by the UE). In case of a high security risk, the UE may generate a new IP address more often than is required to renew registration of the UE with the IP Multimedia Core Network System (also hereafter called an IMS network). The generation of new IP address may result in re-registration to the IMS network. However, reregistration to the IMS network whenever a new IP address is generated by the UE may cause more traffic on the air interface and more processing at entities such as a proxy call state control function (P-CSCF) and a serving call state control function (S-CSCF).

### SUMMARY OF THE INVENTION

Embodiments of the present invention may provide a method of deprecating IP addresses of a communicating entity (such as user equipment or a terminal). This may involve maintaining a database that lists IP addresses of the communicating entity and current usage information (such as ‘in use’ and ‘not in use’) of the IP addresses. The method may also include determining if an IP address stored in the database may be deprecated.

The method may also include marking in the database the IP addresses that are used by any application and/or upper layer of programming of the communicating entity.

The database may store a main IP address used by the communicating entity to register for a network. This main IP address may not be deprecated. However, the communicating entity may perform a new registration with the network by using a new main IP address and deprecating the previously stored main IP address during the new registration.

IP addresses may be generated by the communicating entity by changing at least part (such as the interface identifier) of an IP address that is not the main IP address. The change may utilize autoconfiguration as defined in RFC 3041. The main IP address may be an IP prefix and the prefix may be received from a GGSN, for example, of the network.

Embodiments of the present invention may also provide a network element (such as a user equipment and a terminal) that communicates with other network elements. The network element may include a database listing IP addresses of the network element and current usage information of the IP addresses. The network element may determine from the database if an IP address stored therein may be deprecated.

Other embodiments and salient features of the present invention will become apparent from the following detailed description taken in conjunction with the annexed drawings, which disclose embodiments of the invention.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and that the invention is not limited thereto.

The following represents brief descriptions of the drawings in which like reference numerals represent like elements and wherein:

FIG. 1 is a block diagram of a system for registration according to one arrangement;

FIG. 2 is a block diagram of a system for registration according to another arrangement;

FIG. 3 shows information that may be stored within a database according to an example embodiment of the present invention; and

FIG. 4 is a flowchart showing operations to decide whether to deprecate an IP address according to an example embodiment of the present invention.

### DETAILED DESCRIPTION

In the following detailed description, like reference numerals and characters may be used to designate identical, corresponding or similar components in differing figure drawings. The particulars shown and described herein are by way of example and for purposes of illustrative discussion of embodiments of the present invention. Further, arrangements may be shown in block diagram form in order to avoid obscuring the invention, and also in view of the fact that specifics with respect to implementation of such block diagram arrangements may be highly dependent upon the platform within which the present invention is to be implemented. That is, such specifics should be well within the purview of one skilled in the art. In other instances, detailed descriptions of well-known methods and components are omitted so as not to obscure the description of the invention with unnecessary/excessive detail. Where specific details are set forth in order to describe example embodiments of the invention, it should be apparent to one skilled in the art that the invention can be practiced without, or with variation of, these specific details.

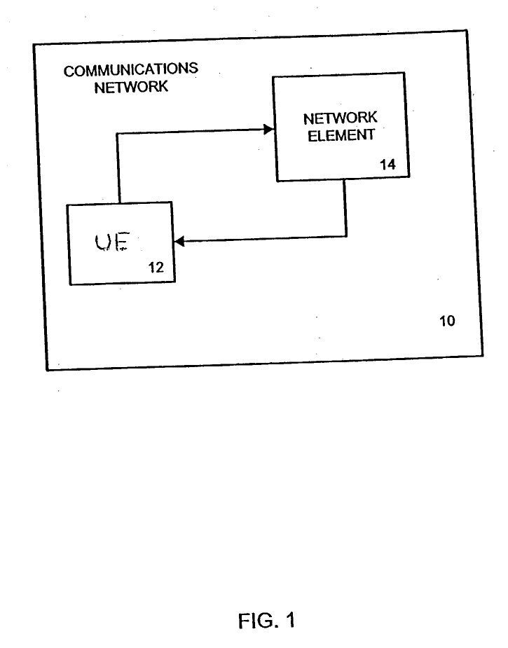

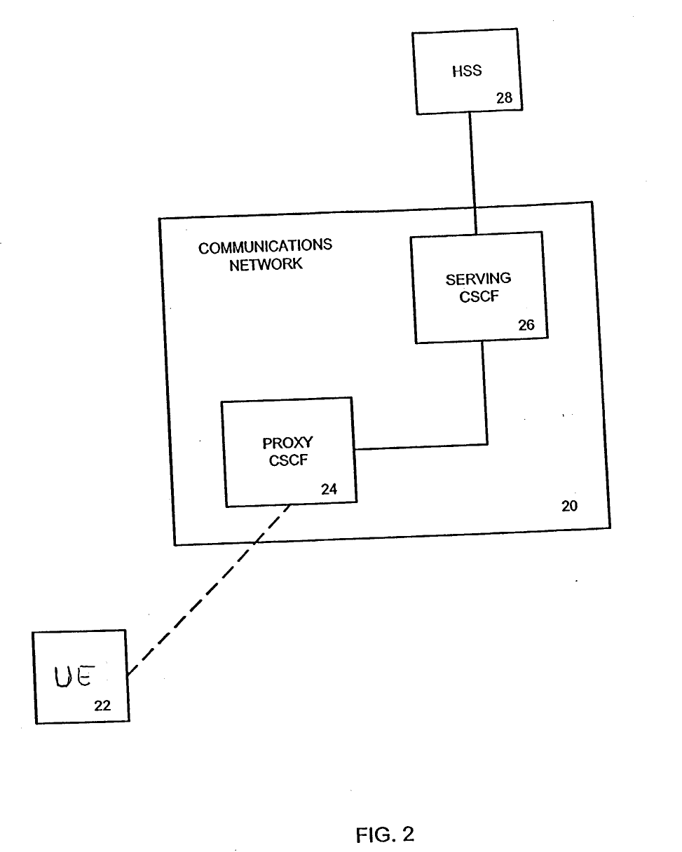

Embodiments of the present invention may relate to user registration in a communications network (such as the IP Multimedia Core Network Subsystem (IMS) of a communications network according to Release 5 of the 3GPP). Example networks that provide user registration, as well as include embodiments of the present invention, will be described below with respect to FIGS. 1 and 2.

FIG. 1 is a block diagram of a system for registration/authentication of a UE according to an example arrangement. Other arrangements are also possible. As shown, a communications network 10 may include a UE 12 and a network element 14. During normal operation, the UE 12 may send a request for registration to the network element 14 to register in the communication network 10. Upon receipt, the network element 14 may perform an authentication process with the UE 12 before registering the UE 12. Once the UE 12 has been authenticated by the network element 14, the UE 12 is then registered in the communication network 10.

FIG. 2 is a block diagram of a system for registration/authentication of a UE according to another arrangement. Other arrangements are also possible. In this example arrangement, a communications network 20 may include a UE 22, a proxy call state control function (P-CSCF) 24 and a serving call state control function (S-CSCF) 26. The UE 22 may interface with the proxy call state control function (P-CSCF) 24, which may in turn interface with the serving call state control function (S-CSCF) 26. The S-CSCF 26 may interface with a Home Subscriber Server (HSS) 28.

The proxy CSCF 24 may contain authentication information regarding the UE 22 that may be used to determine whether the UE 22 is to be registered. The HSS 28 may also contain registration information regarding the UE 22.

Embodiments of the present invention relate to avoiding reregistration to the IMS such as whenever the UE deprecates its current IP address and generates a new one, such as described in RFC 3041. That is, the UE may generate a new IP address (instead of the IP address used to access the IM core network (CN) subsystem) without reregistering to the IMS. This may save bandwidth on the air interface and processing time for other network entities (such as the P-CSCF and the S-CSCF) since it is unnecessary to reregister with the IMS network.

As will now be described and as discussed above with respect to RFC 3041, the UE (such as the UE 12 or 22) may generate a new interface identifier and obtain a new IP address that is different than the previous IP addresses used to access the IM CN subsystem. The UE may eliminate the old IP address and use the new IP address. However, this may cause problems involved with registration/authentication as discussed above.

More specifically, after initial registration an IPv6 host (such as the UE 12 or 22) may generate a new IPv6 address (hereafter called an IP address). This IP address may be valid for a period of time. As described in RFC 3041, this address may be referred to as a ‘preferred temporary address’. The previous IP address may be deprecated in certain implementation such as described in RFC 3041. In order to insure that a preferred temporary address is always available, the new temporary address may be generated slightly before the predecessor address is deprecated. An IP address that is deprecated is no longer in use by upper layers of the programming or applications of the UE and is therefore useless. Accordingly, the host (such as the UE 12 or 22) may wish to remove (or deprecate) such useless IP addresses. The terminology “depreciated” address is defined in Section 3 of RFC 3041 as an IP address that can continue to be used for already established connections but not used to initiate new connections.

In accordance with embodiments of the present invention, before forgetting or removing an earlier used IP address, the UE insures that no upper layers or applications are using that address. This may be accomplished by use of a database that lists IP addresses and current usage information (such as ‘in use’ and ‘not in use’ of the entity. The entity may thereby determine from the information within the database if an IP address may be deprecated. For example, when an IP address published to the IMS network as a contact address is still in use by the upper layers of programming or the application (SIP protocol), then the UE is prevented from forgetting or deprecating the IP address based on the current usage information in the database. The UE is not forced to use the IP address by keeping the IP address within the database, but rather the UE is enabled to receive the packets with that destination address. The UE may still generate new IP address(es) for different purposes and use those IP addresses as desired. An address should not be deprecated when the IP address has been published as a contact address by an upper layer of programming or an application (and in particular by SIP protocol). That is, this type of address should be associated with an ‘in use’ indicator.

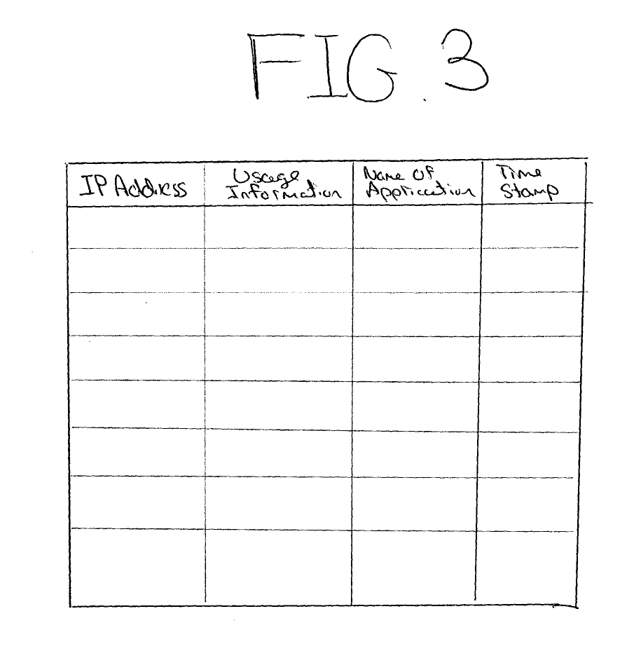

FIG. 3 shows information that may be stored within a database according to an example embodiment of the present invention. Other embodiments and information are also within the scope of the present invention. More specifically, the database may be provided within the UE 12 or 22 (or other entity). The database may store information such as IP Addresses, Usage Information, Name of Application and Time Stamp. As one example, the database may store IPv6 addresses and their associated current usage information (such as ‘in use’ and ‘not in use’).

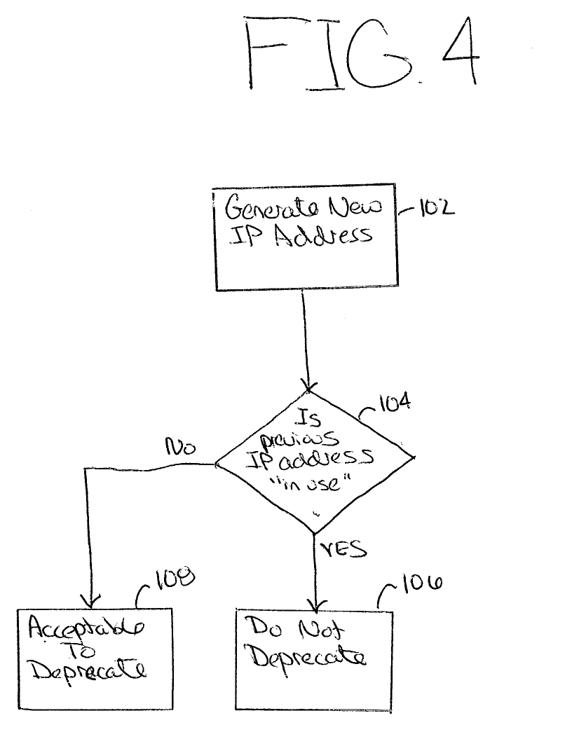

FIG. 4 is a flowchart showing one example of determining whether to deprecate an IP address according to an example embodiment of the present invention. Other embodiments, operations and orders of operation are also within the scope of the present invention. More specifically, in operation 102, a new IP address may be generated at the UE. This new IP address may be stored in the database along with a current usage information indicator that the new IP address is ‘in use’. In operation 104, a decision may be made whether to deprecate another IP address based on the current usage information for the IP address. For example, if the current usage information indicator is ‘in use’ then the entity is forbidden from deprecating the IP address in operation 106. On the other hand, if the current usage information indicator is not ‘in use’ (such as being ‘not in use’) then it is acceptable for the entity to deprecate the IP address in operation 108. While FIG. 3 is shown as relating to the generation of new IP address before the determination regarding whether to deprecate an IP address, other operations or events may also occur prior to the determination of whether to deprecate. Each of these other operations and events is also within the scope of the present invention.

In order to perform embodiments of the present invention, the UE may maintain a database accessible by upper layers of programming (mainly UDP) and the applications. Whenever a new IP address is generated and is passed to upper layers of programming or applications for use, the upper layers or applications write that IP address into the database and mark the IP address as ‘in use’. When the upper layer of programming or an application stops using that specific IP address, then the upper layer of programming or application marks the IP address in the database as ‘not is use’ (i.e., changes the ‘in use’ to ‘not in use’). When an IP address is not marked as ‘in use’ by any upper layer of programming or application (such as when the IP address is marked as ‘not in use’), then the IP address can be deprecated after an implementation specific time. Upper layers of programming or applications that publish the IP addresses for further contact information to external servers/registrars, shall only change ‘in use’ to ‘not in use’ after updating the IP address to a new IP address or removing the contact information from those external databases.

Using stateless autoconfiguration (as in RFC 3041), the UE can freely generate new IP addresses (i.e., the IPv6 addresses) by adding the interface identifier to the IPv6 prefix received from the network. By remembering (i.e. not deprecating) the main IPv6 address that has been used for registration (which is the published IP address or ‘preferred temporary address’ according to RFC 3041) there is no need to keep reregistering with the network.

Embodiments of the present invention may avoid the UE having to reregister to the IMS network whenever the UE deprecates the current IP address and generates a new IP address. That is, the UE may generate a new IP address (instead of the one used to access IM CN Subsystem) without reregistering to the IMS. As such, embodiments of the present invention may save bandwidth on the air interface and the processing time for entities such as the P-CSCF and the S-CSCF since it is unnecessary for the UE to reregister with the IMS network.

While embodiments have been described with respect to IPv6, UE and IMS networks, other networks, entities and protocols are also within the scope of the present invention.

While the invention has been described in terms of preferred embodiments, it should be understood that numerous modifications may be made thereto without departing from the spirit and scope of the invention. It is intended that all such modifications fall within the scope of the appended claims.

What is claimed:

1. A method of deprecating IP addresses of a communicating entity including the steps of:
maintaining a database listing IP addresses of the communicating entity and current usage information of the IP addresses; and
determining from the database if an IP address therein may be deprecated.

2. A method in accordance with claim 1 comprising:
marking in the database the IP addresses which are used by any application of the communicating entity.

3. A method in accordance with claim 2 wherein:
marking in the database the IP addresses which are used by an upper layer of programming of the communicating entity.

4. A method in accordance with claim 3 wherein:
a main IP address used by the communicating entity to register for a network is stored in the database and is not deprecated.

5. A method in accordance with claim 4 wherein:
the communicating entity performs a new registration with the network using a new main IP address which is stored in the database and the previously stored main IP address is deprecated during the new registration.

6. A method in accordance with claim 5 wherein:
IP addresses are generated by the communicating entity by changing at least part of an IP address which is not the main IP address.

7. A method in accordance with claim 6 wherein:
the at least a part which is changed comprises an interface identifier.

8. A method in accordance with claim 7 wherein:
the change uses autoconfiguration as defined in RFC 3041.

9. A method in accordance with claim 7 wherein:
the main IP address comprises an IP prefix.

10. A method in accordance with claim 9 wherein:
the prefix is received from a GGSN of the network.

11. A network element for deprecating IP addresses comprising:
a database listing IP addresses of the network element and current usage information of the IP addresses; and wherein the network element
determines from the database if an IP address therein may be deprecated.

12. A network element in accordance with claim 11 wherein:
the network element marks in the database the IP addresses which are used by any application of the network element.

13. A network element in accordance with claim 12 wherein:
the network element marks in the database the IP addresses which are used by an upper layer of programming of the network element.

14. A network element in accordance with claim 13 wherein:
a main IP address used by the network element to register for a network is stored in the database and is not deprecated.

15. A network element in accordance with claim 14 wherein:
the network element performs a new registration with the network using a new main IP address which is stored in the database and the previously stored main IP address is deprecated during the new registration.

16. A network element in accordance with claim 15 wherein:
IP addresses are generated by the network element by changing at least part of an IP address which is not the main IP address.

17. A network element in accordance with claim 16 wherein:
the at least a part which is changed comprises an interface identifier.

18. A network element in accordance with claim 17 wherein:
the change uses autoconfiguration as defined in RFC 3041.

19. A network element in accordance with claim 18 wherein:
the main IP address comprises an IP prefix.

20. A network element in accordance with claim 19 wherein:
the prefix is received from a GGSN of the network.

21. A network element in accordance with claim 11 wherein:
the IP addresses comprise IPv6 addresses.

22. A network element in accordance with claim 11 wherein:
the network element comprises user equipment.

23. A network element in accordance with claim 11 wherein:
the network element comprises a terminal.
